(19) United States
(12) Patent Application Publication
(10) Pub. No.: US 2022/0131376 A1
(43) Pub. Date: Apr. 28, 2022

(54) SYSTEMS AND METHODS FOR A RECHARGING ACTIVATED DEMAND SHARING SYSTEM FOR AN ELECTRIC VEHICLE

(71) Applicant: RetroRecharge LLC, Norwood, MA (US)

(72) Inventors: James W. Gorman, Norwood, MA (US); Jungtaik Hwang, Dover, MA (US)

(21) Appl. No.: 17/452,145

(22) Filed: Oct. 25, 2021

Related U.S. Application Data
(60) Provisional application No. 63/105,742, filed on Oct. 26, 2020.

(51) Int. Cl. H02J 3/00; H02J 3/32

(52) U.S. Cl. CPC H02J 3/007; H02J 3/322

(57) ABSTRACT

A system for utilizing a single circuit to feed at least two electrical loads when adding an additional load would normally require its own circuit and an upgrade of the electrical service to a dwelling where the circuit is deployed to handle the additional load, including a first electrical component, connected to a circuit and a first load and a second load, the first electrical component configured to power to the first load and second load but disconnect power to the second load when the first load is utilized greater than a threshold ampacity. The first and the second load cannot be fully energized at the same time as the capacity of the circuit would be exceeded.

### CROSS REFERENCE TO RELATED APPLICATIONS

This application is a continuation-in-part of U.S. Provisional Patent Application No. 63/105,742 filed Oct. 26, 2020. This application is hereby incorporated by reference.

### BACKGROUND

Electric vehicles are constantly growing in popularity and usage. In just two years, 2013 to 2015, the number of electric cars worldwide more than doubled. And in the following two years, 2015 to 2017, the number more than doubled again, to just over 3 million. The number of EVs on the road is projected to reach 125 million by 2030 by some measures. This exponential growth means that electric vehicles (EVs) will soon make up a large portion of the global car fleet.

At the same time, infrastructure in both residential and commercial spaces supporting the charging of such vehicles is limited. Charging an electric car may require buildings to have capacity for a larger load, which the existing electrical service of a building or dwelling cannot provide. Electric vehicles need charging facilities, both at various destinations as well as in the home or business. Upgrading these homes and facilities to handle additional capacity may be expensive and intensive, such that businesses are able to invest in and recover revenue from such installation, but homeowners or smaller facilities may not be able to invest. The only known alternatives are to not install and power the new load, eliminate existing load(s) to reduce total load, or to upgrade the electrical service to the building at great expense. Therefore, a more economical way of utilizing existing systems is desirable. There is currently no known available product that allows a single circuit to power multiple loads alternatively so as to allow the installation of more total load than would be allowed on an existing electrical service. Currently, to have four 50 amp loads all would have to be used in calculating the size of the electrical service required. With this new “load switch”, only a single 50 amp load would be used in the calculation. This permits lower costs up-front for new electrical services since the load calculated is lower but more importantly allows for adding new loads to existing electrical services that previously would not have been possible without an expensive electric service upgrade.

### BRIEF SUMMARY

In one embodiment, a system for utilizing a single circuit to feed at least two electrical loads when adding an additional load would normally require a separate circuit and an upgrade of an electrical service to a dwelling where the single circuit is deployed to handle the additional load includes a first electrical component, connected to a circuit and a first load and a second load, the first electrical component configured to power to the first load and the second load and disconnect power to the second load when the first load utilizes greater than a threshold ampacity. The first and second load cannot be fully energized at the same time as a capacity of the circuit would be exceeded. Alternatively, the first electrical component includes a first and second electrical device. In one alternative, the first device is an adjustable current switch that stays open until a load exceeds a first threshold. Alternatively, the second device is a normally closed relay. In another alternative, the first electrical component is configured to continuously route a low level of power to the first load, regardless of whether the first or second load is fully energized. Alternatively, the low level of power is not greater than 0.5 amps. In another alternative, the controlled power is approximately 50 amps. Alternatively, the first load is an appliance and the second load is an electric vehicle charger. In another alternative, the first electrical component is deployed on a circuit where the maximum load is 50 amps.

In one embodiment, a system for utilizing a single circuit to feed at least two electrical loads when adding an additional load would normally require its own circuit and an upgrade of the electrical service to a dwelling where the circuit is deployed to handle the additional load includes a demand sharing system, the recharging activated demand sharing system interconnected to a first and second load, the demand sharing system prioritizing supply of power to the first load over the second load. Alternatively, the recharging activated demand sharing system always provides a low level of power to the first load. In another alternative, when the first load is activated for maximum power consumption, the second load does not receive power. Alternatively, when the first load is only activated in a mode that requires a low level of power, the second load is powered. In another alternative, the first load is an appliance and the second load is an electric vehicle charger. Alternatively, the first and second load cannot be fully energized at the same time as the capacity of the circuit would be exceeded.

In one embodiment, system for utilizing a single circuit to feed at least two electrical loads when adding an additional load would normally require its own circuit and an upgrade of the electrical service to a dwelling where the circuit is deployed to handle the additional load includes a demand sharing system, connected to a circuit and a first and second load, the demand sharing system configured to preferentially fully energize the first load over the second load. Alternatively, the demand sharing system includes a first relay for the first load and a second relay for the second load, the first and second relay configured to provide a selected level of power to each of the first and second load. In one alternative, the demand sharing system includes a controller, the controller receiving power requirements for the first and second load and controlling the first and second relay to provide power to the first and second load. In another alternative, when the first load requires power that utilizes a capacity of the circuit, the controller activates the first relay to provide the capacity of the circuit to the first load and deactivates the second relay to not provide power to the second load. Alternatively, power provided to the first and second load is configurable, such that minimum power supply is established for the first and second load and preferential power supply is established for the first and second load, to preferentially power the first load when a demand for power from the first and second load would exceed the capacity of the circuit. In another alternative, the first load is an appliance and the second load is an electric vehicle charger. Alternatively, the controller is interconnected to a communication device, allowing the controller to be configured via a network connection.

In one embodiment, a method for utilizing a single circuit to feed at least two electrical loads when adding an additional load would normally require its own circuit and an upgrade of the electrical service to a dwelling where the circuit is deployed to handle the additional load includes preferentially energizing a first load over a second load using a demand sharing system, connected to the circuit and the first and second load. Alternatively, the demand sharing system includes a first relay for the first load and a second relay for the second load, the first and second relay configured to provide a selected level of power to each of the first and second load. In another alternative, the demand sharing system includes a controller, the controller receiving power requirements for the first and second load and controlling the first and second relay to provide power to the first and second load.

### BRIEF DESCRIPTION OF THE DRAWINGS

FIG. 1 shows one embodiment of a recharging activated demand sharing system;

FIGS. 2 and 3 show embodiments of wiring diagrams for embodiments of a recharging activated demand sharing system; and

FIG. 4 shows a schematic diagram for an embodiment of a recharging activated demand sharing system.

### DETAILED DESCRIPTION

Certain terminology is used herein for convenience only and is not to be taken as a limitation on the embodiments of the systems and methods for a recharging activated demand sharing system (REDS for short) for an electric vehicle. Embodiments of REDS allows for the retrofitting of existing systems without costly electrical service upgrades to a dwelling. In many embodiments, an existing dwelling or building includes an electrical power service having a maximum possible amperage draw from the mainline power grid. A customer or user may desire to include an additional load on the building's electrical system. The inclusion of this additional load on the building's electrical system may cause the total possible load on the electrical system to exceed the designed capacity of the system. Although the designed capacity of the system may be exceeded by the installation, in many scenarios, the loads on the system may not actually exceed the electrical load capacity at any one time due to intermittent use of individual loads.

This may occur because various loads on the system may include a dishwasher, a dryer for clothing, a washing machine for clothing, and other loads that run infrequently, but draw a significant load. In one example, the designed capacity of an electrical system may be 100 amps and may consist of 4 loads, each estimated to meet a peak of 25 amps. Operationally, only 3 of the 4 loads are likely to operate at one time, which causes the actual maximum load of the system to be 75 amps at any one time except under extreme operating conditions. If a consumer desires to add another 25 amp load to the system, due to building codes and safety regulations, an electrician or electrical installer will be unable to make such an installation, without upgrading the electrical service of the dwelling/building. This requires a significant capital investment and an upgrading of the mainline to the dwelling/building. These mainline services are typically referred to as service drops (in the case of overhead power connections) or service laterals (in the case of underground power connections). Service drops and service laterals are highly regulated and cannot be changed or upgraded without working with the power company. Additionally, the consumer is responsible for new meter sockets, electrical panels, conductors, and other components.

Embodiments of the REDS provides for a retrofit system that eliminates or avoids the need for such electrical service upgrades. The service drop or lateral to a dwelling/building need not be upgraded or modified in many embodiments of the system. The REDS system provides for a load management system that ensures that the designed capacity of the electrical system is not exceeded. In many embodiments, the main service panel is connected via the mainline (service drop or lateral). The main service panel then distributes power to a number of circuits. In many dwellings, the load capacity will be 100 or 200 amps (and 400 in very large dwellings with electrical heating, although no load size should be imputed to limit the subject matter described herein). One circuit of the system may include a load capacity that is for instance, 50 amps. This circuit may feed an appliance deployed on a 50 amp circuit that utilizes the entire capacity of the circuit. An additional load that will potentially utilize the entire 50 amp capacity of the circuit is desired to be deployed on the same circuit. An embodiment of the REDS may be deployed at the start of the circuit, which splits the circuit into feeds for the existing appliance load and the additional load. The REDS includes a load monitoring system that only allows for activation of the additional load when the load drawn from the existing appliance load is very small or non-existent. In one example, the additional load may be a charging station for an electric vehicle and the existing appliance load may be an electric range. The electric range is unlikely to be operating continuously, especially during nighttime hours, when the electric vehicle is likely to be charging.

In some embodiments, it may be necessary to maintain a small amount of power to the appliance (e.g. electric oven), since they operate in a standby mode when not in use, providing for timing function for automatic start, etc. Power routing to accommodate this may be included.

In many embodiments, a user is unable to install an additional electrical load without having to upgrade the total possible load of the system.

In one embodiment, a REDS or “Load Switch” device is an electrically controlled switching device that monitors the amount of current being drawn by one large load (such as an electric range) and upon a certain threshold it automatically disconnects the power to a second large load (such as an electric car charger) until the first load is turned off. The current threshold can be set to allow constant power to the first load enough to power control circuits and lighting (such as the clock on an electric range) and only trigger the disconnect of the second load when the measured current exceeds the minimum requirement for low current functions. The device is intended to power two loads of the same size, maximum of 50 amps each. These load sizes are only exemplary.

In another embodiment, a REDS or “Load Switch” device allows for the connection of two comparable electrical loads to be connected and energized such that the overall load on the electrical service is unchanged. The REDS functions by disconnecting power to a secondary load whenever the primary load is drawing more than an allowable maximum current sufficient to power necessary low wattage control circuits. An example would be having an electric oven as the primary load and an electric car charger as the secondary. Both the electric oven and the charger receive constant power but when the oven is turned on for use beyond the simple function of a clock display the device automatically disconnects the power to the charger until the oven is turned off. Thus, two large loads are able to share the same existing allowable ampacity without overloading the electrical service. Preferably the primary load is one that is infrequently used allowing the secondary load to have full power the majority of the time.

In another embodiment, a REDS or Smart Power Controller device allows for the connection of two or more (diagram depicts a three-device unit) electric loads to be connected such that the overall load on the electrical service is unchanged. It can be used with both “Smart Power” aware devices and regular devices. The Smart Power Controller will prioritize the loads in sequential order that will guarantee that the overall load of the circuit, and hence the main electric panel, is not overloaded. It is similar to the “Load Switch” in function, except that when paired with Smart Power aware (SP Aware) aware devices, a small amount of current to control the electronic control components will be maintained to all the loads.

Additionally, in some embodiments the REDS may monitor the historical times that the usage of various loads occurs and preplan for switching of the system accordingly by implementing computer-controlled logic.

Many embodiments of the REDS or “Load Switch” device are meant to solve a common problem where a residential electric customer attempts to add a load (such as an electric car charger or hot tub) to their electrical service that it cannot handle. This problem generally occurs in homes where they are using electricity for any combination of cooking, hot water, clothes drying, etc. Typically, the solution is to either not install the new load or to update the electrical service to the home (such as going from 100 amps to 200 amps) which may involve significant costs. The “Load Switch” device allows for the new desired load to be added to the existing electrical service by allowing two loads (such as an electric range and an electric car charger) to use the same circuit, but not at the same time. The primary load (such as the electric range) would preferentially have power and work upon demand. The secondary load (such as the new electric car charger) would have its constant power feed only disconnected when the primary load was in use. Under normal conditions, with the primary load (such as an electric range) only being used for a minimal percentage of time per average 24-hour period, the secondary load (such as an electric car charger) would be at full power for the majority of the time and therefore be able to complete its functions with little disruption or loss of capability.

Many embodiments of the REDS or “Load Switch” device solve the common problem of an electric utility customer wishing to add a large load (50 amps) to their electrical service for which it cannot adequately handle. The existing solution to this problem is to upgrade the electrical service at great expense. With the load switch device, the customer would have the option of taking an existing known large load on the electrical service and share it with the new load. This allows for the installation and powering of the new load without the cost of upgrading the electrical service by automatically switching between the two loads as demand requires.

Additionally, many embodiments of the REDS or load switch device solve the problem that utility companies have with customers adding additional load to their infrastructure/grid which it cannot handle as demand increases with the advent of electric cars. This device allows the customer to add additional load capability without adding load/stress to the utility. Utility companies may view this device as a potential solution to the problem of ever increasing demand upon their undersized infrastructure. In some scenarios, the power supplied to an entire neighborhood or branch of the electrical grid may already be at capacity, so no upgrades may be possible without significant investments from the power company. The use of REDS allows the utility to cap the potential load on the grid at existing ampacities while still allowing customers to add new loads.

Embodiments of the REDS or “Smart Power Controller” solve a similar problem as the “Load Switch” with a couple of enhancements. First, through the use of a controller, it supports more than two loads. Second, with the incorporation of more advanced and sensitive electronic circuitry, more and more devices today aren't designed to be disconnected from power on a regular basis. Often, advanced devices will generate warnings and sometimes catastrophic results can occur if power is suddenly cut off during a critical function (e.g. firmware flash upgrade).

Embodiments of the REDS or load switch device solve the problem of a utility customer not having enough power to feed a new load by presenting the option of sharing an existing load with the new load without upgrading the electrical service. A primary load is selected to “share” with the new secondary load and the device provides power to the more frequently used secondary device until such time as the primary load draws greater than an allowable ampacity. During the duration of the primary load being used, the secondary load is disconnected. Once the current of the primary load drops below threshold, power is restored to the secondary load. This allows the secondary load to have full power the majority of the time, only disconnected when the less used primary load is on during minimal use. An example of this would be a residential electric range as the primary load used infrequently and an electric car charger as the secondary load utilized for greater periods of time per day and night.

Additionally, embodiments of the REDS or load switch device solve the problem that utility companies have with customers adding additional load to their infrastructure which it cannot handle. This device allows the customer to add additional load capability without adding load/stress to the utility. The solution is similar to the “Load Switch”, except it is enhanced to be able to support more than two loads. It also allows a small amount of current to be maintained to power sensitive electronic control equipment.

Additionally, embodiments of the REDS or “Load Switch” device could be used for customers who have limited existing allowable ampacity on their electric service to add any new load that is capable of having power occasionally interrupted such as an electric car charger, hot tub, A/C, electric heat or heat pump.

Additionally, the load switch device solves the problem that utility companies have with customers adding additional load to their infrastructure which it cannot handle. This device allows the customer to add additional load capability without adding load/stress to the utility.

In one embodiment of a REDS, a normally open current switch is connected to the primary load which closes when current is greater than 0.5 amps that is controlling a normally closed relay feeding the secondary load. The relay feeding the secondary load remains open until the current switch on the primary load returns to open state. This permits the installation of two 50 amp loads from a single 50 amp feed without allowing both to be on concurrently and overloading the electric service capabilities.

In another embodiment of a REDS, a single 50 amp 240 volt 4-wire feed is run from the main electric panel into the load switch device. The feed is connected to both a 50 amp rated normally open current switch and a 50 amp rated normally closed relay with a 240 volt coil. Two individual 50 amp feeds are run from the load switch device to the primary and secondary loads. The primary load is connected to the load side of the N/O current switch and the secondary load is connected to the load side of the N/C relay. When the N/O current switch detects greater than 0.5 amps of current on the primary load it closes, sending 240 volts to the coil of the N/C relay causing it to open and disconnect power to the secondary load. When the current being drawn by the primary load returns to below 0.5 amps the N/O current switch opens, disconnecting the 240 volts from the coil on the N/C relay causing it to close and restore power to the secondary load.

Embodiments of the “Load Switch Device” or REDS can be of any amperage or voltage rating depending on the load requirements. Single or three phase alternatives are also possible. For simplicity, examples described herein are shown as single phase, 240 volts, 50 amp maximum current draw.

In another embodiment of a REDS, a device, labeled “Smart Power Controller” consists of a controller, Wi-Fi module for connectivity, and a set of relays (one for each load device). Other components for additional features and safety as required by local codes will also be included. The device is configured using a mobile app on the user's smartphone or computer, connected through industry standard wireless communication technology, including but limited to Wi-Fi, Bluetooth, and NFC.

In many embodiments of a REDS, the system supports “Smart Power Aware” (SP Aware) devices and regular loads, increasing the compatibility. However, only SP Aware devices will be able to continue drawing a small amount of power during periods where higher priority loads are switched on and operating. This enables SP Aware devices to continue to power their control load (<0.5 amps), to enable low-draw sensitive electronic equipment to continue function (e.g. digital clock, Wi-Fi connectivity, firmware upgrades, etc.). When non-SP Aware devices are connected, the circuit is simply disconnected through a relay when a higher priority load is drawing more than 0.5 amps, essentially behaving the same way as the “Load Switch” device.

SP Aware devices incorporate the use of a “Smart Power Microcontroller”, which serves as a control module, constantly communicating with the Smart Power Controller. The communication signal will operate over industry standard powerline communication technologies, including but not limited to HomePlug AV/AV2 (IEEE 1901) standards. The SP Aware devices will notify the SP Controller that they will be using higher draw amounts, when in turn the SP Controller will notify all lower priority SP Aware devices to turn off the functional load (but still preserve power to the control load). All Non-SP Aware, lower priorities devices will simply have their circuits disconnected (similar to the Load Switch)

The SP Controller also enables scheduling capabilities. For example, if two 50 amp loads are connected, the system can be pre-programmed so that one load gets power from midnight to 3 am and the second load gets power from 3 am to 6 am. An application of this scheduling capabilities would be if a homeowner has two electric vehicles and they want to control the charging cycles of both vehicles, without exceeding the electric load for the main electric panel.

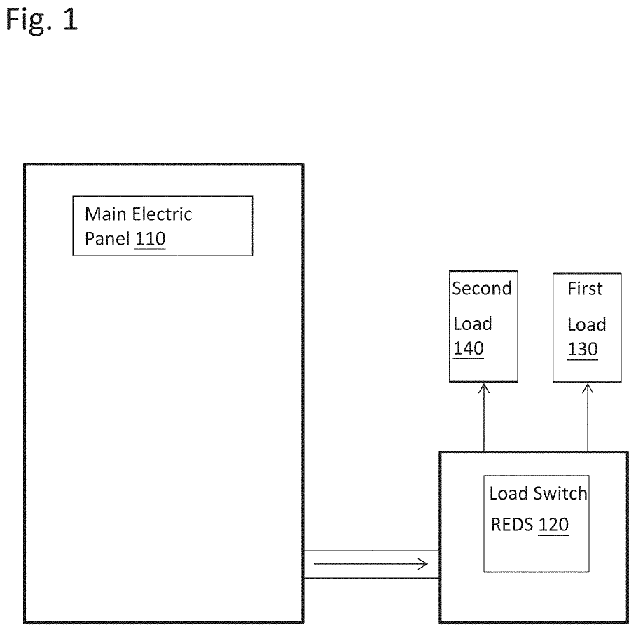

FIG. 1 shows one embodiment of a REDS system. This embodiment enables the powering of two loads that would normally exceed the capacity of the circuit to which the loads are connected. In this configuration, main electrical panel 110 is interconnected to REDS 120. A current of 50 amps is provided to REDS 120, which is the maximum possible output provided by the main electrical panel 110 to this circuit based on the wiring of the dwelling. REDS 120 provides electrical current to two appliances/loads 130, 140. In this case, appliances/loads 130, 140 each are designed to draw approximately the maximum possible amperage that this circuit can provide. In this case, it is 50 amps. However, based on the usage of appliances/loads 130, 140, they are unlikely to experience concurrent usage. By way of example, appliance/load 130 may be an electric oven and appliance/load 140 may be an electric vehicle charger. Based on the unlikely occurrence of concurrent usage, REDS 120 controls power to appliances/loads 130, 140. If concurrent usage occurs, REDS 120 preferentially provides power to one of the appliances/loads 130, 140 and deactivates power to the other. In many scenarios, preferential power is given to the appliance/load 130 that finds traditional home usage, in this case an electric oven. In many alternatives, some small degree of power is provided to appliance/load 130, which is typically not enough to trip the circuit breaker or other current control mechanism of the main electrical panel. In many embodiments, appliance/load 140 may be slightly underpowered in order to provide an uninterrupted low level of current to appliance/load 130. This in many cases is done because appliances such as ovens have constantly on low power functions, such as timers, clocks, or other features. The slight underpowering of appliance/load 140 typically will not interrupt or effect operation. Note that this scenario is exemplary for illustrative purposes and in actual scenarios, the circuit may have more than merely two loads on the circuit. Therefore, it may be more straightforward to provide uninterrupted low power to appliances. For instance, if two appliances are provided, accounting for 25 amps each on a 50 amp circuit and an additional load of 25 amps for an electric vehicle charger, then in operation, 0.5 amps may be provided to each of the appliances while the electric vehicle charger may operate drawing 25 amps. When one of the appliances is activated, then the vehicle charger may be deactivated.

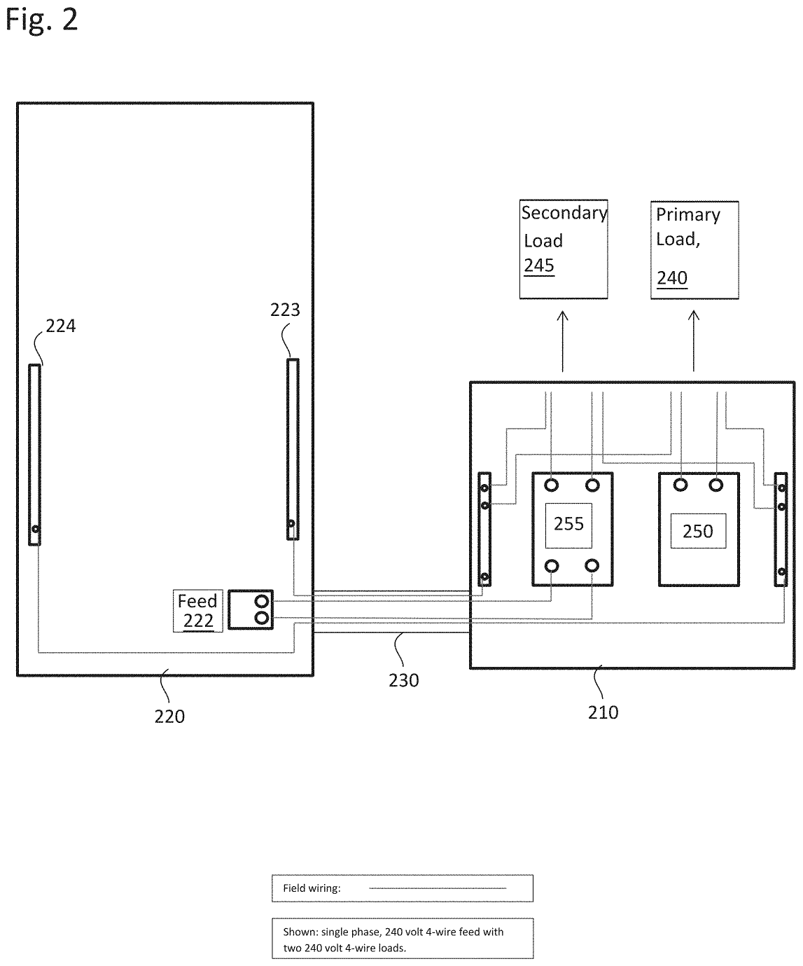

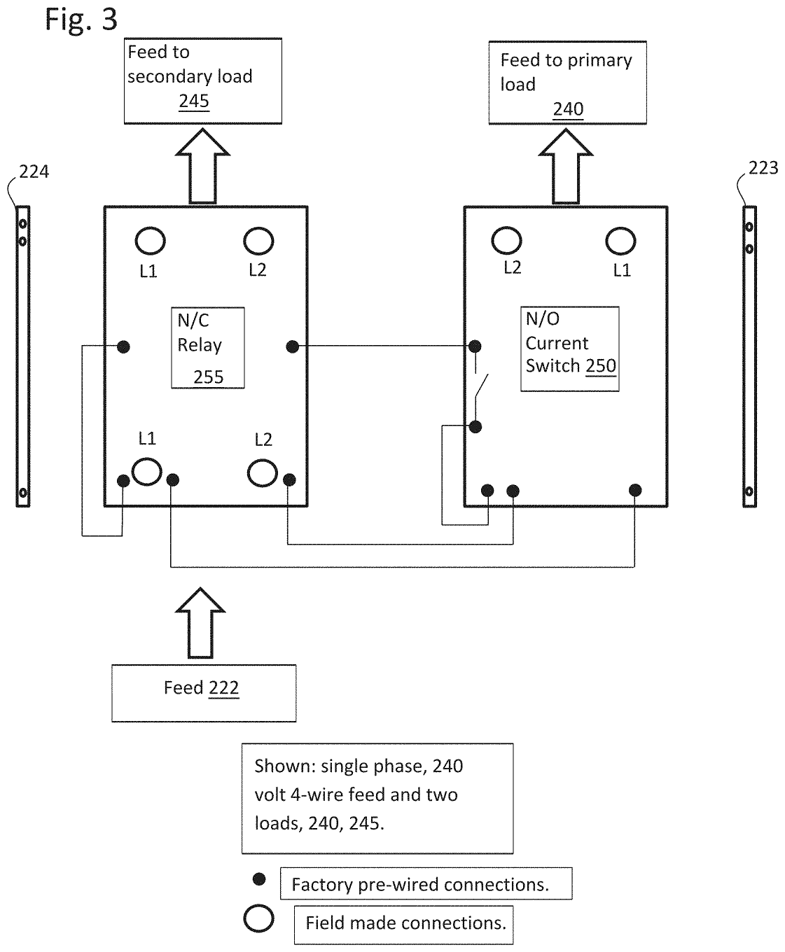

FIGS. 2 and 3 shows wiring diagrams for another embodiment of a REDS 210, with FIG. 3 showing a closer more detailed view of the REDS 210. Main electrical panel 220 includes 50 amp power distribution legs 222, ground 223, and neutral connection 224. Electrical conduits 230 (wires) provide interconnection to REDS 210, which is subsequently interconnected to primary load 240 and secondary load 245.

In this configuration, two devices are provided. Device A 250 is an adjustable normally open current switch. Device B 255 is a normally closed relay. Device A 250 operates as a switch based on a measurement of current. Device B 255 in many embodiments is a normally closed relay. In many embodiments, Device A 250 is an adjustable current switch that will stay open until the current exceeds a certain amperage. In operation, the secondary load 245 will draw uninterrupted power as long as the primary load 240 is drawing less than the set amperage on the current switch.

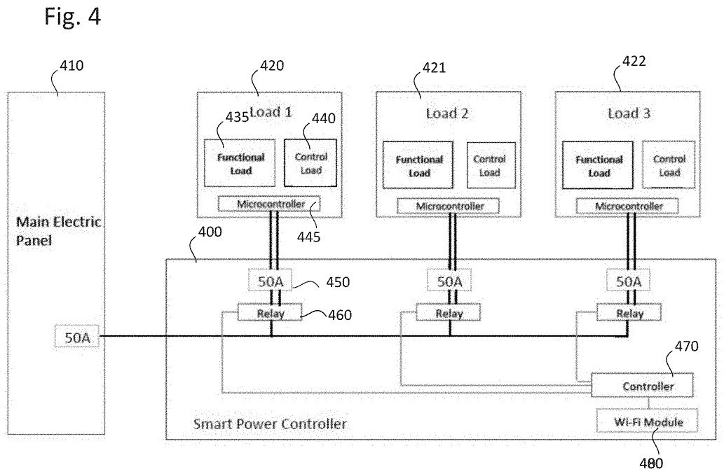

FIG. 4 shows another embodiment of REDS 400. Here, main electric panel 410 provides a 50 amp current to REDS 400 (Smart Power Controller). In this configuration, three loads 420, 421, 422 are connected to REDS 400. Each of these loads may use 50 amps of power and therefore may not run simultaneously. Each of the loads 420, 421, 422 includes a microcontroller 430 and a functional load 435 and a control load 440. In many scenarios, the control load is a low-level load, typically in the range of 0.5 amps. The control load 440 is typically used for low power functions, such as running the clock and timer of a system. Functional load 435 is typically a higher power function approaching, in this case, 50 amps. For example, this may be when the oven or dishwasher or other function is running to perform its designed function. The microcontroller 445 of the loads is typically for managing the power demand of the device. Microcontroller 445 also typically relays a signal from the various loads to the controller. This signal in many scenarios includes the state of operation of the device. It also may include the planned operation of the device according to usage schedules programed in by the user to the load itself (for instance a user may program a clothing dryer or oven to start and operate at a certain time, which may be communicated to the via the microcontroller 445 to the controller 470. The REDS 400 includes a 50 amp power source 450 for powering each of the loads 420, 421, 422. Additionally, the REDS 400 includes a relay 460. Relay 460 receives a signal from controller 470 as to whether to allow power to each of the corresponding loads 420, 421, 422 as well as relaying a signal from the microcontroller 445 of loads 420, 421, 422 to controller 470. Controller 470 may include logic and other software to operate the relays 460 to maintain power as the user prioritizes or as is defined by the needs or operations of loads 420, 421, 422.

Additionally, controller 470 may be interconnected to a wi-fi module 480, allowing for communication with external devices. In alternatives, wi-fi module 480 may be a different type of communication module, such as a cellular communication module, a Bluetooth communication module, a hardwired connection (USB or other) or any such communication module as would occur to one of ordinary skill in the art. In operation, REDS 400 is designed to operate such that via controller 470 the system is programmable to control relay 460. Relay 460 prioritize how the loads 420, 421, 422 are operated and energized according to various logic schemes, which in many cases may be programmable/configurable. For instance, the provision of power to loads 420, 421, 422 may be prioritized, so that the first load 420 is energized completely if operated in a state that requires full power. Furthermore, the second load 421 may be energized in preference to energizing the third load 422. The third load 422 may be given the lowest priority. Additionally, the programmed schemes/logic may be significantly more complex than this type of priority and may involve other variables other than priority and power demand. For instance, timing may be included, as is typically, if one of the devices is a vehicle charging unit for electric vehicles. For instance, the microcontroller may be programmed to preferentially energize the third load 422 at night and the other loads during the day. In some configurations, the controller 470 may collect and monitor historical usage data in order to plan for and provide warnings concerning possible usage conflicts. Moreover, this data may be transmitted to a power company or other entity for more centralized planning. In some embodiments, two or more REDS 400 may be interconnected together to manage two power supplies. Internal logic implemented in the controllers 470 or at a remote location, may implement logic enabling the most efficient power distribution. This allows a maximum number of loads to be energized according to usage patterns and defined user needs.

Controller 470 may take many forms depending on the embodiment. In some embodiments, controller 470 is a microcontroller. In some embodiments, controller 470 may be a circuit with a series of switches or dials for configuring a minimum continuous power for a load and a preference order for energizing the loads. For instance, a first dial on the controller may be for selecting a minimum continuous power supply, such as from 0 to 20 amps (or any possible logic range), for the first load 420. A second dial may be for selecting a preference order for energizing the first load 420 (from 1 to 3). Two additional sets of dials may be included, one for each of the second and third load, operating in a similar fashion. This is just one example of an electro-mechanical configuration, and many alternatives will occur.

In many embodiments, parts of the system are provided in devices including microprocessors. Various embodiments of the systems and methods described herein may be implemented fully or partially in software and/or firmware. This software and/or firmware may take the form of instructions contained in or on a non-transitory computer-readable storage medium. Those instructions then may be read and executed by one or more processors to enable performance of the operations described herein. The instructions may be in any suitable form such as, but not limited to, source code, compiled code, interpreted code, executable code, static code, dynamic code, and the like. Such a computer-readable medium may include any tangible non-transitory medium for storing information in a form readable by one or more computers such as, but not limited to, read only memory (ROM); random access memory (RAM); magnetic disk storage media; optical storage media; a flash memory, etc.

Embodiments of the systems and methods described herein may be implemented in a variety of systems including, but not limited to, smartphones, tablets, laptops, and combinations of computing devices and cloud computing resources. For instance, portions of the operations may occur in one device, and other operations may occur at a remote location, such as a remote server or servers. For instance, the collection of the data may occur at a smartphone, and the data analysis may occur at a server or in a cloud computing resource. Any single computing device or combination of computing devices may execute the methods described.

In various instances, parts of the method may be implemented in modules, subroutines, or other computing structures. In many embodiments, the method and software embodying the method may be recorded on a fixed tangible medium.

While specific embodiments have been described in detail in the foregoing detailed description, it will be appreciated by those skilled in the art that various modifications and alternatives to those details could be developed in light of the overall teachings of the disclosure and the broad inventive concepts thereof. It is understood, therefore, that the scope of this disclosure is not limited to the particular examples and implementations disclosed herein but is intended to cover modifications within the spirit and scope thereof as defined by the appended claims and any and all equivalents thereof.

1. A system for utilizing a single circuit to feed at least two electrical loads when adding an additional load would normally require a separate circuit and an upgrade of an electrical service to a dwelling where the single circuit is deployed to handle the additional load, the system comprising:
a first electrical component, connected to a circuit and a first load and a second load, the first electrical component configured to power to the first load and the second load and disconnect power to the second load when the first load utilizes greater than a threshold ampacity, wherein the first and second load cannot be fully energized at the same time as a capacity of the circuit would be exceeded.

2. The system of claim 1, wherein the first electrical component includes a first and second electrical device.

3. The system of claim 2, wherein the first device is an adjustable current switch that stays open until a load exceeds a first threshold.

4. The system of claim 3, wherein the second device is a normally closed relay.

5. The system of claim 4, wherein the first electrical component is configured to continuously route a low level of power to the first load, regardless of whether the first or second load is fully energized.

6. The system of claim 5, wherein the low level of power is not greater than 0.5 amps.

7. The system of claim 6, wherein the controlled power is approximately 50 amps.

8. The system of claim 7, wherein the first load is an appliance and the second load is an electric vehicle charger.

9. The system of claim 8, wherein the first electrical component is deployed on a circuit where the maximum load is 50 amps.

10. A system for utilizing a single circuit to feed at least two electrical loads when adding an additional load would normally require its own circuit and an upgrade of the electrical service to a dwelling where the circuit is deployed to handle the additional load, the system comprising:
a demand sharing system, the recharging activated demand sharing system interconnected to a first and second load, the demand sharing system prioritizing supply of power to the first load over the second load.

11. The system of claim 10, wherein the recharging activated demand sharing system always provides a low level of power to the first load.

12. The system of claim 11, wherein when the first load is activated for maximum power consumption, the second load does not receive power.

13. The system of claim 12, wherein when the first load is only activated in a mode that requires a low level of power, the second load is powered.

14. The system of claim 13, wherein the first load is an appliance and the second load is an electric vehicle charger.

15. The system of claim 10, wherein the first and second load cannot be fully energized at the same time as the capacity of the circuit would be exceeded.

16. A system for utilizing a single circuit to feed at least two electrical loads when adding an additional load would normally require its own circuit and an upgrade of the electrical service to a dwelling where the circuit is deployed to handle the additional load, the system comprising:
a demand sharing system, connected to a circuit and a first and second load, the demand sharing system configured to preferentially fully energize the first load over the second load.

17. The system of claim 16, wherein the demand sharing system includes a first relay for the first load and a second relay for the second load, the first and second relay configured to provide a selected level of power to each of the first and second load.

18. The system of claim 17, wherein the demand sharing system includes a controller, the controller receiving power requirements for the first and second load and controlling the first and second relay to provide power to the first and second load.

19. The system of claim 18, wherein when the first load requires power that utilizes a capacity of the circuit, the controller activates the first relay to provide the capacity of the circuit to the first load and deactivates the second relay to not provide power to the second load.

20. The system of claim 18, wherein power provided to the first and second load is configurable, such that minimum power supply is established for the first and second load and preferential power supply is established for the first and second load, to preferentially power the first load when a demand for power from the first and second load would exceed the capacity of the circuit.

21. The system of claim 20, wherein the first load is an appliance and the second load is an electric vehicle charger.

22. The system of claim 21, wherein the controller is interconnected to a communication device, allowing the controller to be configured via a network connection.

23. A method for utilizing a single circuit to feed at least two electrical loads when adding an additional load would normally require its own circuit and an upgrade of the electrical service to a dwelling where the circuit is deployed to handle the additional load, the method comprising:
preferentially energizing a first load over a second load using a demand sharing system, connected to the circuit and the first and second load.

24. The method of claim 23, wherein the demand sharing system includes a first relay for the first load and a second relay for the second load, the first and second relay configured to provide a selected level of power to each of the first and second load.

25. The method of claim 24, wherein the demand sharing system includes a controller, the controller receiving power requirements for the first and second load and controlling the first and second relay to provide power to the first and second load.
